(19) United States
(12) Patent Application Publication
(10) Pub. No.: US 2024/0239253 A1
(43) Pub. Date: Jul. 18, 2024

(54) VENTILATED SEAT

(71) Applicant: Lear Corporation, Southfield, MI (US)

(72) Inventors: Bradley Clifford Duncan, Harrison Township, MI (US); Vyachislav Ivanov, West Bloomfield, MI (US); Caleb Andrew Abbey, Warren, MI (US); Ted Laverne Smith, Waterford, MI (US)

(73) Assignee: Lear Corporation, Southfield, MI (US)

(21) Appl. No.: 18/096,713

(22) Filed: Jan. 13, 2023

(51) Int. Cl. B60N 2/56; B60N 2/809; B60N 2/879

(52) U.S. Cl. CPC B60N 2/5657; B60N 2/809; B60N 2/879

(57) ABSTRACT

A ventilated seat including a seatback; a seat ventilation system engaging the seatback and including a blower and a duct to direct airflow from the blower; a pair of vertically extending headrest support posts, with at least one of the headrest support posts being hollow, having a first end located within the seatback and operatively engaging the duct to receive the airflow from the blower, and a vent hole extending from the hollow interior to a front surface, the vent hole located in the vertically extending portion of the headrest support post and directing the airflow forward onto a neck or head of a seat occupant; and a headrest mounted on and supported by the pair of headrest support posts, with the headrest adjustable up and down relative to the seatback. The seat ventilation system may include arm, calf or face ventilation openings.

### BACKGROUND OF THE INVENTION

This invention relates to a seat having ventilation.

Ventilated seats are known that provide heating, ventilation and air conditioning to occupants of the seats. Typically, ventilation air flows, in a distributed manner, through a porous seat trim (upholstery) onto the back, buttocks and underside of thighs of the seat occupant. This distributed airflow may take some time to provide noticeable comfort to the seat occupant. It is desirable to provide a more effective means for providing thermal comfort to an occupant of a seat.

### SUMMARY OF THE INVENTION

According to an aspect, the invention provides a ventilated seat including: a seatback; a seat ventilation system operatively engaging the seatback and including a blower and a duct configured to direct airflow from the blower; a pair of generally vertically extending headrest support posts, with at least one of the headrest support posts being hollow, having a first end located within the seatback and operatively engaging the duct to receive the airflow from the blower, and at least one vent hole extending from the hollow interior to a front surface, the at least one vent hole located in the generally vertically extending portion of the at least one headrest support post and configured to direct the airflow forward onto a neck, head or both of a seat occupant; and a headrest mounted on and supported by the pair of headrest support posts, the headrest configured to be adjustable up and down relative to the seatback.

According to an aspect, the invention provides a ventilated seat including: a seat bottom having a nose region at a front of the seat bottom; and a seat ventilation system operatively engaging the seat bottom and including a blower and a duct configured to direct airflow from the blower to a calf opening, with the calf opening extending through the nose region, under the nose region, or both, and configured to direct the airflow onto calves of a seat occupant.

According to an aspect, the invention provides a ventilated seat comprising: a seatback having a pair of seatback bolsters, each having an arm opening extending through a respective one of the seatback bolsters; and a seat ventilation system operatively engaging the seatback and including a blower and ductwork configured to direct airflow from the blower to the arm openings, with the arm openings configured to direct the airflow from the ductwork onto arms of a seat occupant.

According to an aspect, the invention provides a ventilated seat including: a seat bottom having a top surface with a face opening extending through a top surface of the seat bottom at a location configured to be between lower thighs or knees of the seat occupant; and a seat ventilation system operatively engaging the seat bottom and including a blower and a duct configured to direct airflow from the blower through the face opening onto a face, a chest, or both, of a seat occupant.

According to an aspect, the invention provides a ventilated seat capable of directing airflow directly onto specific locations of a seat occupant. According to an aspect, airflow delivery onto a seat occupant specifically targets thermally sensitive regions of the seat occupant's body such as a head, a neck, arms, calves, chest, face or any combination thereof. According to an aspect, the ventilated seat provides airflow from headrest support posts onto a seat occupant either directly, through a headrest, or both. According to an aspect, the ventilated seat provides ventilation air, heated air, cooled (air conditioned (A/C)) air or selectively all three onto a seat occupant. According to an aspect, the ventilated seat provides airflow from bolsters of a seatback onto arms of a seat occupant. According to an aspect, the ventilated seat provides airflow from a nose region of a seat bottom onto calves of a seat occupant, an adjacent footwell of a vehicle, or both. According to an aspect, the ventilated seat provides airflow from a top surface of a seat bottom onto a chest, a face, or both of a seat occupant.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a schematic, perspective view of a ventilated seat.

FIG. 2 is a schematic, front view of a portion of a seat.

FIG. 3 is a schematic, side view of a portion of a seat.

FIG. 4 is a schematic, front view of a portion of a seat.

FIG. 5 is a schematic, front view of a portion of a seat.

FIG. 6 is a schematic, front view of a portion of a seat.

FIG. 7 is a schematic, front view of a portion of a seat.

FIG. 8 is a schematic, side view of a portion of a seat.

FIG. 9 is a schematic, front view of a portion of a seat.

FIG. 10 is a schematic, side view of a portion of a seat.

FIG. 11 is a schematic, front view of a portion of a seat.

FIG. 12 is a schematic, front view of a portion of a seat.

FIG. 13 is a schematic, rear view of a portion of a seat.

FIG. 14 is a schematic, front view of a portion of a seat.

FIG. 15 is a schematic, front view of a portion of a seat.

FIG. 16 is a schematic, side view of a portion of a seat.

FIG. 17 is a schematic, front view of a portion of a seat.

FIG. 18 is a schematic, side view of a portion of a seat.

FIG. 19 is a schematic, front view of a portion of a seat.

FIG. 20 is a schematic, side view of a portion of a seat.

FIG. 21 is a schematic, rear view of a portion of a seat.

### DETAILED DESCRIPTION OF THE PREFERRED EMBODIMENTS

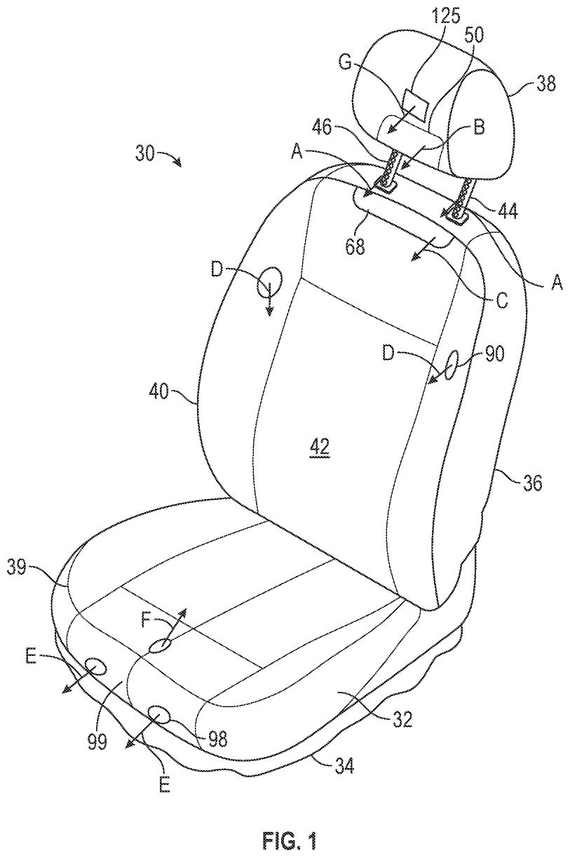

Referring now to the example illustrated in FIG. 1, a portion of a vehicle seat 30 is shown. The vehicle seat 30 is contemplated to be employed in an automotive vehicle, although the vehicle seat 30 is contemplated to be employed in other types of vehicles. The vehicle seat 30 includes a seat bottom 32, which is mounted to vehicle structure 34, upon which a seat occupant sits. A seatback 36 is secured relative to the seat bottom 32 and supports the seat occupant's back. The vehicle seat 30 includes a headrest 38 mounted to and extending upward from the seatback 36. The terms front, back, up, down and side relate to a typical vehicle seat that faces forward in an automotive vehicle while in a position to allow a person (seat occupant) to sit on the vehicle seat 30. The seat bottom 32 has side bolsters 39 that provide side support to the seat occupant's thighs, and the seatback 36 has side bolsters 40 that provide side support to the seat occupants back. Seat trim (upholstery) 42 covers the seat bottom 32 and seatback 36. The seat trim 42 may have perforations or otherwise allow for distributed airflow onto the seat occupant's back, buttocks and under the seat occupant's thighs. The seat trim 42 is made of leather, cloth, or other suitable materials for covering the vehicle seat 30.

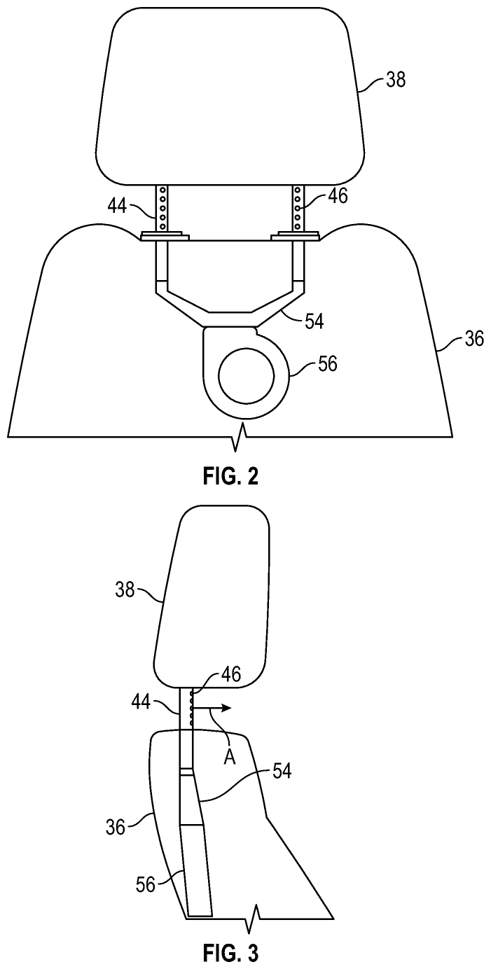

Referring now to the example illustrated in FIGS. 1-6, the headrest 38 is supported above the seatback 36 by a pair of generally vertically extending headrest support posts 44. The headrest support posts 44 are hollow tubes. At least one of the headrest support posts 44 includes a plurality of vent holes 46. The vent hole 46 are located on the front face of the respective headrest support posts 44 in order to direct airflow within the hollow tubes forward towards a neck, head, or both of the seat occupant. A bottom end of the at least one headrest support posts 44 operatively engages ductwork 54, which in turn operatively engages a blower 56. The blower 56 may be part of a heating, ventilation and air conditioning (HVAC) system associated with the vehicle seat 30 and may be mounted in the seatback 36. The blower 56 may direct airflow to other parts of the vehicle seat 30 or just to the headrest support posts 44. Electrical power (not shown) may be provided to the blower 56 in a conventional way that electrical power is provided to various seat functions, which is known to those skilled in the art.

The headrest support posts 44 are selectively slidable relative to at least one of the seatback 36 and the headrest 38. In the instant example being discussed relative to FIGS. 1-6, the headrest support posts 44 are selectively slidable relative to the headrest 38. The headrest 38 may include at least one recessed pocket 48 in a front side of headrest foam surrounding the corresponding headrest support post 44, with a headrest vent panel 50 or a headrest bezel 52 covering over the one or more recessed pockets 48. The headrest vent panel 50 includes perforations 58 to allow airflow through the panel 50 out of the front of the headrest 38, and the headrest bezel 52 includes louvers 60, which may be directionally adjustable, to direct airflow through the headrest bezel 52 out of the front of the headrest 38.

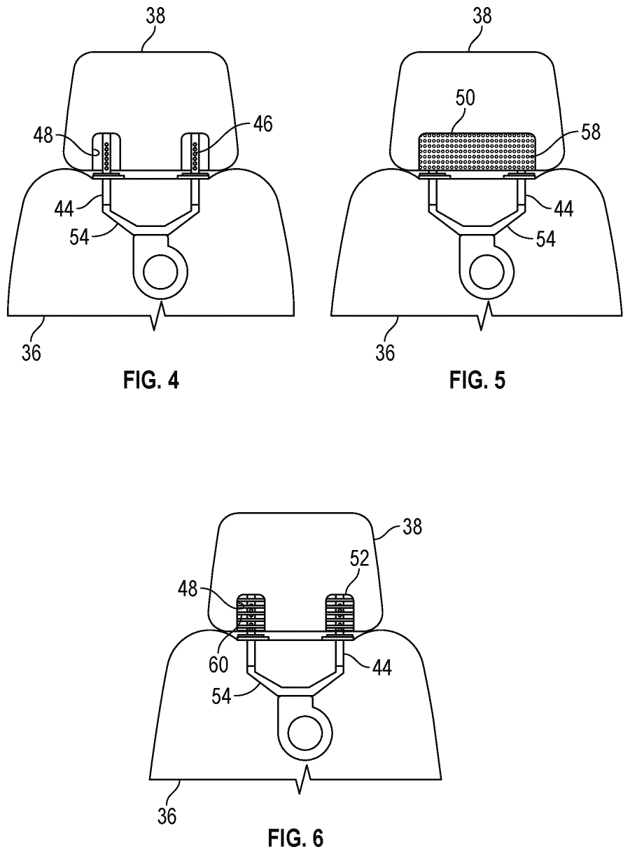

Accordingly, when the headrest 38 is in a fully raised position (relative to the seatback 36, see for example FIGS. 1-3) the airflow created when the blower 56 is activated flows through the ductwork 54, within the hollow headrest support posts 44, and out from the vent holes 46 (see arrows A) onto the neck, head, or both of the seat occupant. When the headrest 38 is in a fully lowered position (see for example FIGS. 4-6) the airflow created when the blower 56 is activated flows through the ductwork 54, within the hollow headrest support posts 44, out from the vent holes 46, through the recessed pockets 48, and through the perforations 58—or louvers 60 as the case may be—(see arrows B) onto the neck, head, or both of the seat occupant. When the headrest 38 is in an intermediate position (partially raised/lowered), then the airflow may be directed partially through the perforations 58/louvers 60 (Arrow B) and partially directly from the vent holes 46 (Arrows A) that are exposed below the headrest 38. The airflow coming from the blower 56 may selectively be ventilation air, heated air or cooled (air conditioned (A/C)) air.

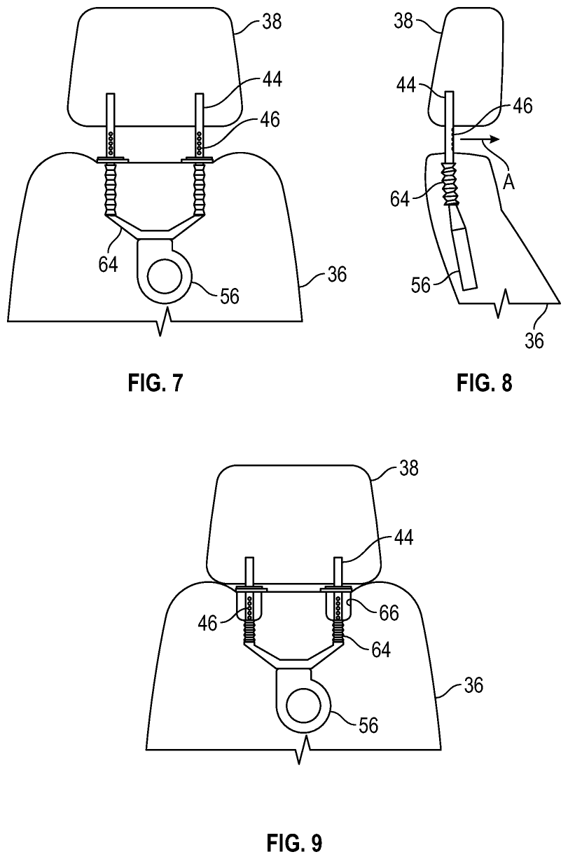

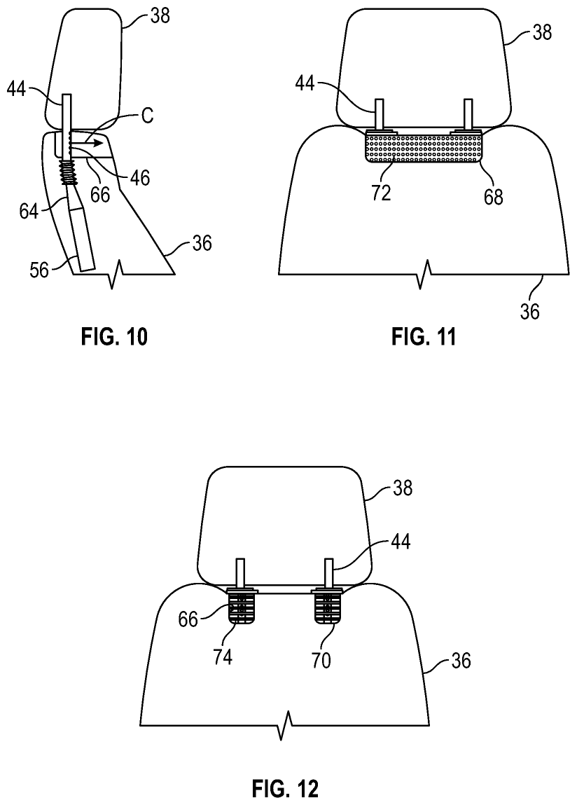

Referring now to the example illustrated in FIGS. 1 and 7-12, the headrest 38 is supported above the seatback 36 by the pair of generally vertically extending headrest support posts 44. The headrest support posts 44 are hollow tubes. At least one of the headrest support posts 44 includes the plurality of vent holes 46. The vent hole 46 are located on the front face of the respective headrest support posts 44 in order to direct airflow within the hollow tubes forward towards the neck, head or both of the seat occupant. The bottom end of at least one of the headrest support posts 44 operatively engages ductwork 64, which in turn operatively engages the blower 56. The ductwork 64 is flexible to allow the ductwork 64 to vertically extend and retract when the headrest 38 is raised and lowered so that the upper end of the ductwork 64 remains engaged with the headrest support posts 44 in the various raised/lowered positions of the headrest 38. The blower 56 may be part of the heating, ventilation and air conditioning (HVAC) system associated with the vehicle seat 30 and may be mounted in the seatback 36. The blower 56 may direct airflow to other parts of the vehicle seat 30 or just to the headrest support posts 44. Electrical power (not shown) may be provided to the blower 56 in a conventional way that electrical power is provided to various seat functions, which is known to those skilled in the art.

The headrest support posts 44 are selectively slidable relative to at least one of the seatback 36 and the headrest 38. In the instant example being discussed relative to FIGS. 1 and 7-12, the headrest support posts 44 are selectively slidable relative to the seatback 36. The seatback 36 may include at least one recessed pocket 66 in a front side of seatback foam surrounding the corresponding headrest support post 44, with a seatback vent panel 68 or a seatback bezel 70 covering over the one or more recessed pockets 66. The seatback vent panel 68 includes perforations 72 to allow airflow through the vent panel 68 out of the front of the seatback 36, and the seatback bezel 70 includes louvers 74, which may be directionally adjustable, to direct airflow through the seatback bezel 70 out of the front of the seatback 36.

Accordingly, when the headrest 38 is in a fully raised position (relative to the seatback 36, see for example FIGS. 1, 7 and 8) the airflow created when the blower 56 is activated flows through the ductwork 64, within the hollow headrest support posts 44, and out from the vent holes 46 (see arrows A) onto the neck, head, or both of the seat occupant. When the headrest 38 is in a fully lowered position (see for example FIGS. 9-12) the airflow created when the blower 56 is activated flows through the ductwork 64, within the hollow headrest support posts 44, out from the vent holes 46, through the recessed pockets 66, and through the perforations 72—or louvers 74 as the case may be—(see arrows C) onto the neck, head, or both of the seat occupant. When the headrest 38 is in an intermediate position (partially raised/lowered), then the airflow may be directed partially through the perforations 72/louvers 74 (Arrows C) and partially directly from the vent holes 46 (Arrows A) that are exposed above the seatback 36. The airflow coming from the blower 56 may selectively be ventilation air, heated air or cooled (A/C) air.

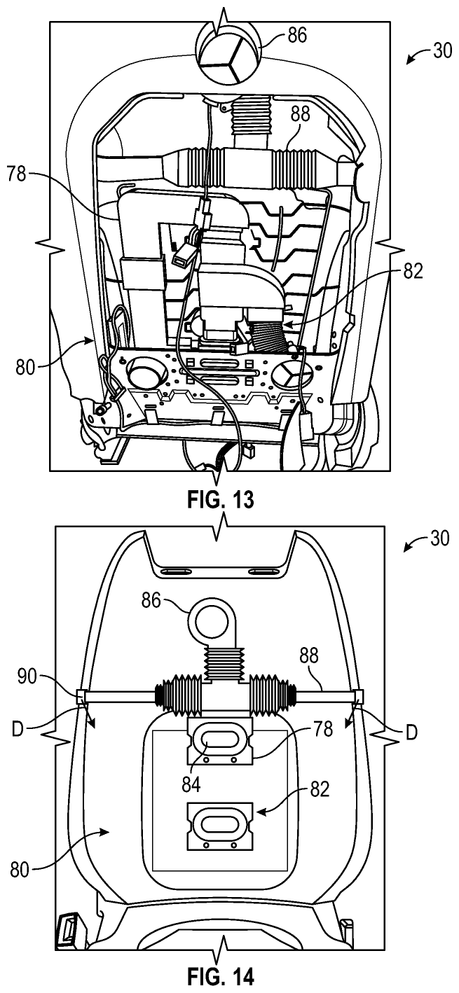

Referring now to the example illustrated in FIGS. 1 and 13-14, the ventilated seat 30 includes a seatback portion 78 of a seat ventilation system 80. The seatback portion 78 may include a blower and duct system 82 that distributes airflow through duct openings 84 to a back of a seat occupant. The seatback portion 78 includes an arm blower 86 that directs airflow into arm ducts 88 that direct air to arm outlets 90 located in the side bolsters 40 of the seatback 36. The seat trim 42 may be perforated at the location of the arm outlets 90 or may include a bezel/louver apparatus at the arm outlets 90. It is contemplated that the arm outlets 90 direct airflow onto the back, side or both of the upper arms of the seat occupant. Thus, when the arm blower 86 is activated, airflow is directed through the arm ducts 88, and out of the arm outlets 90 (see Arrows D) onto the seat occupant's arms. The airflow coming from the arm blower 86 may selectively be ventilation air, heated air or cooled (A/C) air.

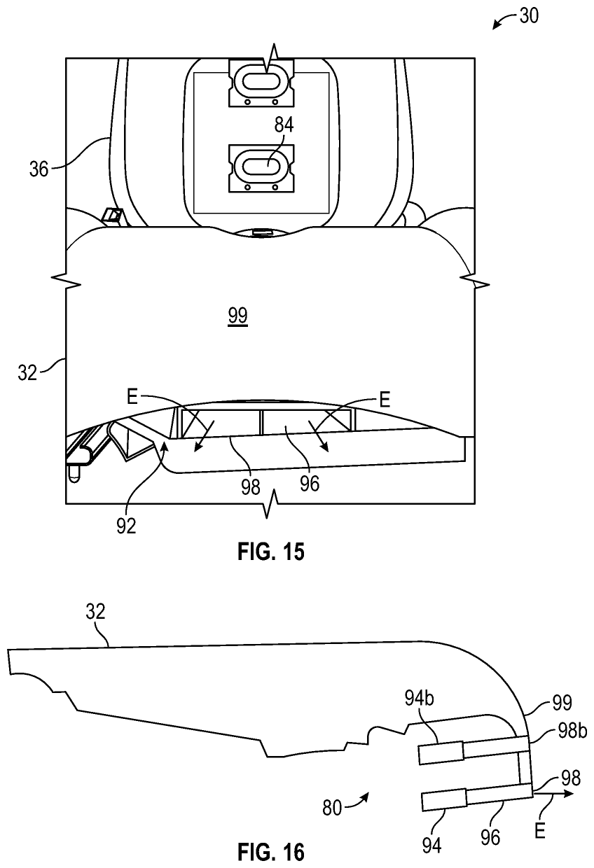

Referring now to the example illustrated in FIGS. 1 and 15-16, the ventilated seat 30 includes a seat bottom portion 92 of a seat ventilation system 80. The seat bottom portion 92 includes at least one calf blower 94 that directs airflow into calf duct(s) 96 that direct air to calf outlet(s) 98 located under a nose region 99 of the seat bottom 32. Additional (or optional) locations for the calf blower 94b and calf outlet(s) 98b are contemplated that extend through rather than under the nose region 99. Additionally, the calf blowers 94, 94b may include a device for heating the airflow, cooling the airflow or both. The seat trim 42 may be perforated at the location of the calf outlet(s) 98/98b or may include a bezel/louver apparatus at the calf outlet(s) 98/98b. It is contemplated that the calf outlet(s) 98/98b directs airflow onto the back of the calves of the seat occupant, into the footwell region of the vehicle, or both. Thus, when the calf blower 94/94b is activated, airflow is directed through the calf duct(s) 96, and out of the calf outlet(s) 98/98b (see Arrows E) onto the seat occupant's calves. The airflow coming from the calf blower 94 may selectively be ventilation air, heated air or cooled (A/C) air.

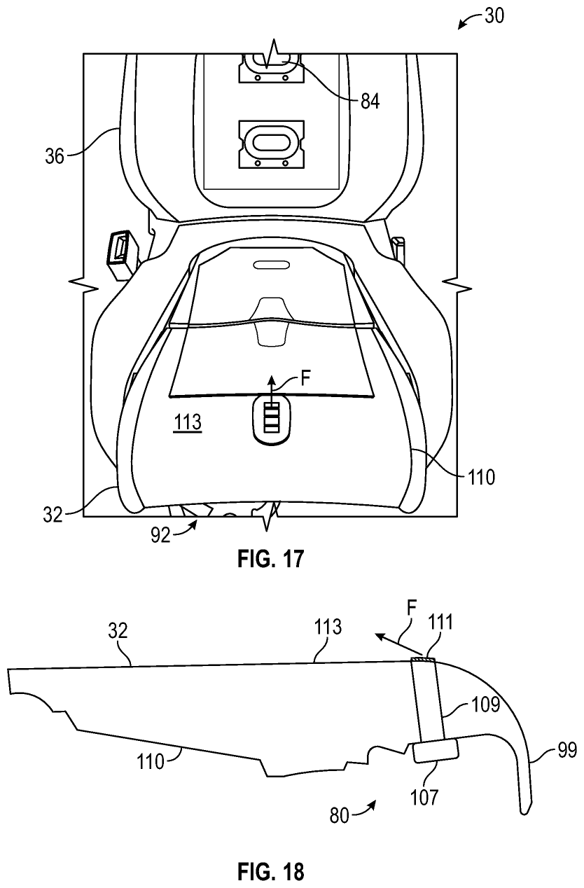

Referring now to the example illustrated in FIGS. 1 and 17-18, the ventilated seat 30 includes the seat bottom portion 92 of a seat ventilation system 80. The seat bottom portion 92 includes at least one face blower 107 that directs airflow into at least one face duct 109, extending through seat bottom foam 110, that directs air to at least one face outlet 111 located on a top surface 113 of the seat bottom 32 near the nose region 99—that is, far enough forward on the seat bottom 32 so that the face outlet 111 is located adjacent to a lower thigh area of the seat occupant between the seat occupant's legs. Additionally, the face blower 107 may include a device for heating the airflow, cooling the airflow or both. The seat trim 42 may be perforated at the location of the face outlet 111 or may include a bezel/louver apparatus at the face outlet 111. It is contemplated that the face outlet 111 directs airflow between the seat occupant's thighs and onto the face of the seat occupant, onto the chest of the vehicle occupant, or both. Thus, when the face blower 107 is activated, airflow is directed through the face duct 109, and out of the face outlet 111 (see Arrows F) onto the seat occupant's face/chest. The airflow coming from the face blower 107 may selectively be ventilation air, heated air or cooled (A/C) air.

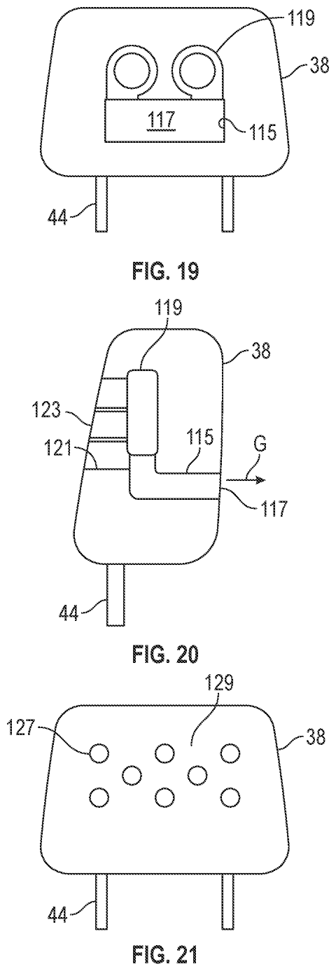

Referring now to the example illustrated in FIGS. 1 and 19-21, The headrest 38 is illustrated, with a pair of headrest support posts 44 that operatively engage the vehicle seat 30. A front recess 115 in foam of the headrest 38 includes a front opening 117, for directing airflow out of the headrest 38, and space for mounting at least one (two shown in FIG. 19) headrest blower 119. The front recess 115 may taper from the headrest blower 119 to the front opening 117. A rear recess 121 in the foam of the headrest 38 includes a rear opening 123 for drawing air into the headrest 38. The rear opening 123 may be covered by a vent panel 129 having perforations 127 that allow air to flow into the rear of the headrest 38. The front opening 117 may also be covered by a vent panel or a bezel. When the one or more headrest blowers 119 are activated, air is drawn in through the rear opening 123 and airflow is directed through front opening 117, and out of the vent panel 125 (see Arrows G) onto the seat occupant's head, neck or both. The airflow coming from the headrest blowers 119 may selectively be ventilation air, heated air or cooled (A/C) air.

The principle and mode of operation of this invention have been explained and illustrated in its preferred embodiment. However, it must be understood that this invention may be practiced otherwise than as specifically explained and illustrated without departing from its spirit or scope.

1. A ventilated seat for use by a seat occupant, the ventilated seat comprising:
a seatback;
a seat ventilation system operatively engaging the seatback and including a blower and a duct configured to direct airflow from the blower;
a pair of generally vertically extending headrest support posts, with at least one of the headrest support posts being hollow, having a first end located within the seatback and operatively engaging the duct to receive the airflow from the blower, and at least one vent hole extending from the hollow interior to a front surface, the at least one vent hole located in the generally vertically extending portion of the at least one headrest support post and configured to direct the airflow forward onto a neck, head or both, of the seat occupant; and
a headrest mounted on and supported by the pair of headrest support posts, the headrest configured to be adjustable up and down relative to the seatback.

2. The ventilated seat of claim 1 wherein each post of the pair of headrest support posts is hollow, has the first end located within the seatback and operatively engaging the duct to receive the airflow from the blower, and each of the posts has at least one vent hole extending from the respective hollow interior to the respective front surface, with the at least one vent hole in each of the posts located in the respective generally vertically extending portion and configured to direct the airflow forward onto the neck, the head or both, of the seat occupant.

3. The ventilated seat of claim 1 wherein the headrest includes a recessed pocket through which the at least one of the headrest support posts is extendable, with the recessed pocket configured to allow for airflow from the at least one vent hole through the recessed pocket and onto the neck, the head or both, of the seat occupant.

4. The ventilated seat of claim 3 wherein the recessed pocket is open to a front surface of the headrest and the headrest includes a headrest vent panel covering the recessed pocket, with the headrest vent panel including perforations configured to allow airflow from the at least one vent hole through the perforations.

5. The ventilated seat of claim 3 wherein the recessed pocket is open to a front surface of the headrest and the headrest includes a headrest bezel and louvers covering the recessed pocket configured to direct airflow from the at least one vent hole between the louvers and onto the neck, the head or both, of the seat occupant.

6. The ventilated seat of claim 1 wherein the duct is a flexible duct configured to extend when the headrest is raised relative to the seatback and contract when the headrest is lowered relative to the seatback while maintaining operative engagement with the at least one of the headrest support posts.

7. The ventilated seat of claim 6 wherein the seatback includes a recessed pocket through which the at least one of the headrest support posts is extendable, with the recessed pocket configured to allow for airflow from the at least one vent hole through the recessed pocket and onto the neck, the head, or both, of the seat occupant.

8. The ventilated seat of claim 7 wherein the recessed pocket is open to a front surface of the seatback and the seatback includes a seatback vent panel covering the recessed pocket, with the seatback vent pane including perforations configured to allow airflow from the at least one vent hole through the perforations.

9. The ventilated seat of claim 7 wherein the recessed pocket is open to a front surface of the seatback and the seatback includes a seatback bezel and louvers covering the recessed pocket configured to direct airflow from the at least one vent hole between the louvers and onto the neck, the head or both, of the seat occupant.

10. The ventilated seat of claim 1 wherein the at least one vent hole is a plurality of vent holes spaced vertically along the at least one headrest support post.

11. The ventilated seat of claim 1 wherein the seatback includes a pair of seatback bolsters; and the seat ventilation system includes a pair of arm ducts operatively engaging the blower and a pair of arm openings, each of the arm openings extending through a respective one of the seatback bolsters, the arm openings configured to direct the airflow from respective ones of the arm ducts onto arms of the seat occupant.

12. The ventilated seat of claim 1 further including a seat bottom operatively engaging the seatback, the seat bottom including at least one calf opening extending through a nose region of the seat bottom, and at least one calf duct configured to direct the airflow from the seat ventilation system through the calf openings onto calves of the seat occupant.

13. The ventilated seat of claim 1 further including a seat bottom operatively engaging the seatback, the seat bottom including at least one face opening extending through a top surface of the seat bottom at a location configured to be between lower thighs or knees of the seat occupant, and at least one face duct configured to direct the airflow from the seat ventilation system through the at least one face opening onto a face, a chest, or both, of the seat occupant.

14. The ventilated seat of claim 1 wherein the seat ventilation system includes a second blower mounted within the headrest, and the headrest includes an air intake extending from a rear of the headrest to the second blower and an air outlet extending from the second blower to a front surface of the headrest configured to direct the airflow forward onto the neck, the head, or both, of the seat occupant.

15. A ventilated seat for use by a seat occupant, the ventilated seat comprising:
a seat bottom having a nose region at a front of the seat bottom; and
a seat ventilation system operatively engaging the seat bottom and including a blower and a duct configured to direct airflow from the blower to a calf opening, with the calf opening extending through the nose region, under the nose region, or both, and configured to direct the airflow onto calves of the seat occupant.

16. The ventilated seat of claim 15 wherein the seat bottom further includes at least one face opening operatively engaging the seat ventilation system, the face opening extending through a top surface of the seat bottom at a location configured to be between lower thighs or knees of the seat occupant and configured to direct the airflow from the seat ventilation system through the at least one face opening onto a face, a chest, or both, of the seat occupant.

17. The ventilated seat of claim 15 further including a seatback operatively engaging the seat bottom and having a pair of seatback bolsters, each having an arm opening extending through a respective one of the seatback bolsters, and wherein the seat ventilation system includes a pair of arm ducts operatively engaging respective ones of the arm openings, with the arm openings configured to direct the airflow from respective ones of the arm ducts onto arms of the seat occupant.

18. A ventilated seat for use by a seat occupant, the ventilated seat comprising:
a seatback having a pair of seatback bolsters, each having an arm opening extending through a respective one of the seatback bolsters; and
a seat ventilation system operatively engaging the seatback and including a blower and ductwork configured to direct airflow from the blower to the arm openings, with the arm openings configured to direct the airflow from the ductwork onto arms of the seat occupant.

19. The ventilated seat of claim 18 further including a seat bottom, and wherein the seat bottom further includes at least one face opening operatively engaging the seat ventilation system, the face opening extending through a top surface of the seat bottom at a location configured to be between lower thighs or knees of the seat occupant and configured to direct the airflow from the seat ventilation system through the at least one face opening onto a face, a chest, or both, of the seat occupant.

20. A ventilated seat for use by a seat occupant, the ventilated seat comprising:
a seat bottom having a top surface with a face opening extending through a top surface of the seat bottom at a location configured to be between lower thighs or knees of the seat occupant; and
a seat ventilation system operatively engaging the seat bottom and including a blower and a duct configured to direct airflow from the blower through the face opening onto a face, a chest, or both, of the seat occupant.
